(19) United States
(12) Patent Application Publication
(10) Pub. No.: US 2006/0185464 A1
(43) Pub. Date: Aug. 24, 2006

(54) Rotary actuator

(75) Inventors: Robert J. Telep, Livonia, MI (US); Peter G. Weissinger, Sterling Heights, MI (US); Murray Busato, Clinton Township, MI (US)

Correspondence Address: Patent Docket Administrator;BorgWarner Inc., 3850 Hamlin Road, Auburn Hills, MI, 48326, US

(73) Assignee: BorgWarner Inc., Auburn Hills, MI (US)

(21) Appl. No.: 11/266,981

(22) Filed: Nov. 4, 2005

Related U.S. Application Data
(60) Provisional application No. 60/654,924, filed on Feb. 22, 2005.

(51) Int. Cl. G05G 1/04

(52) U.S. Cl. 74/519

(57) ABSTRACT

The present invention relates to a linkage assembly for obtaining a mechanical advantage having a first lever having a first end and a second end. The first and second levers are connected by mechanical connection. The mechanical connection is made of the second end of the first lever as being a pin that is slidable disposed within a slot formed on the second end of the second lever. In order to prevent build up of debris between the slot and the pin another embodiment of the present invention incorporates the use of anti-contamination members. Another embodiment of the invention involves placing a guard member on the pin in order to prevent the build up of debris between the pin and slot. The guard member includes scrapers that will scrap debris off the slot as the pin slides along the slot.

### CROSS-REFERENCE TO RELATED APPLICATIONS

This application claims the benefit of U.S. Provisional Application No. 60/654,924, filed Feb. 22, 2005. The disclosures of the above application(s) is (are) incorporated herein by reference.

### FIELD OF THE INVENTION

The present invention relates to linkage assemblies that control boost pressure in turbochargers and their use in combination with internal combustion engines.

### BACKGROUND OF THE INVENTION

Turbochargers are generally well known in the art. The basic function of a turbocharger is to increase air flow going into the intake manifold of the engine. Increasing the pressure of the air going into the intake manifold, and hence the piston cylinders, increases the power of the engine. Turbochargers are powered by exhaust gas pressure flowing into a turbine, which in turn rotates a compressor. The compressor is connected to the intake manifold, as the compressor increases in speed, the air pressure going into the intake manifold increases as well. One method used for controlling the flow of exhaust gas into the turbine is the use of a series of vanes circumferentially spaced evenly around the turbine. The turbochargers that use vanes in the way described here are generally known as variable geometry turbochargers. As the vanes change position, the pressure of the exhaust gas flowing into the turbine can be increased or decreased. The vanes are all connected to a single ring, and as the ring rotates, the vanes change position. The ring is typically connected to a shaft; the shaft is fixed about a pivot point for rotation. As the shaft rotates about the pivot point, the ring rotates, changing the position of the vanes. Rotating the shaft is accomplished by a linkage assembly, connected to an actuator.

The torque required to move the shaft may vary with the degree of rotation. The variation is caused by friction within the vanes and by debris that can accumulate on the linkage assembly with normal usage.

A linkage is used to interconnect the shaft of the actuator and the shaft connected to the ring. The linkage also provides a mechanical advantage that will increase the torque provided by the actuator as the linkage moves through its rotation.

FIG. 1 shows a common four-bar link prior art design at 10 with various pivot points. It consists of lever 12 attached to the shaft 14 of an actuator 16 and another lever 18 that is attached to the shaft 20 of a control mechanism (not shown). The levers 12 and 18 are joined together by a link 22, that has pivot connections 24, and 26, allowing movement therebetween. The mechanical advantage at a given shaft rotation is determined by the ratio of the effective length of the levers 12 and 18.

Typical linkage designs consist of a four-bar linkage assembly, with various pivot points. A common problem that occurs when using this type of design is the limited ability of the four-bar linkage to closely match the mechanical advantage to the torque required by the vanes through rotation. As previously mentioned, friction within the vanes and debris are the two main causes for the torque to vary with degree of rotation. The debris that builds up on the linkage is from the exhaust gases, which results from normal engine operation. Over time, the debris build up can worsen, having a greater effect on the use of the linkage.

### SUMMARY OF THE INVENTION

The present invention relates to a linkage assembly for obtaining a mechanical advantage having a first lever having a first end and a second end. The first end of the first lever is connected to an actuator and is rotatable about the first end. There is also a second lever having a moveable first end connected to a device that is being controlled by the linkage assembly. The second lever also has a second end. The second end of the first lever and the second end of the second lever are operably connected together by a mechanical connection. The mechanical connection of the first and second levers are connected in such a way that a variable mechanical advantage is created by varying the effective length of one or more of the levers when the actuator rotates the first lever.

In one embodiment, the mechanical connection for operably connecting the second end of the first lever and second end of the second lever is a pin and slot configuration. The mechanical connection is formed by the second end of the first lever being a pin that is slidable disposed within a slot formed on the second end of the second lever. In order to prevent build up of debris between the slot and the pin another embodiment of the present invention incorporates the use of anticontamination members. Another embodiment of the invention incorporates a guard member on the pin in order to prevent the build up of debris between the pin and slot. In an alternate embodiment, the guard member also has scrapers that scrap debris off the slot as the pin slides along the slot.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a side plan view of a conventional four-bar linkage assembly;

FIG. 2 is a side plan view of the present invention;

FIG. 3 is another side plan view of the present invention;

FIG. 4 is an exploded side plan view of the pin and slot;

FIG. 5 is an exploded perspective view of the pin and guard assembly; and

FIG. 6 is an exploded perspective view of an alternate embodiment securing the guards to the pin and guard assembly according to the present invention.

### DETAILED DESCRIPTION OF THE PREFERRED EMBODIMENTS

The following description of the preferred embodiment(s) is merely exemplary in nature and is in no way intended to limit the invention, its application, or uses.

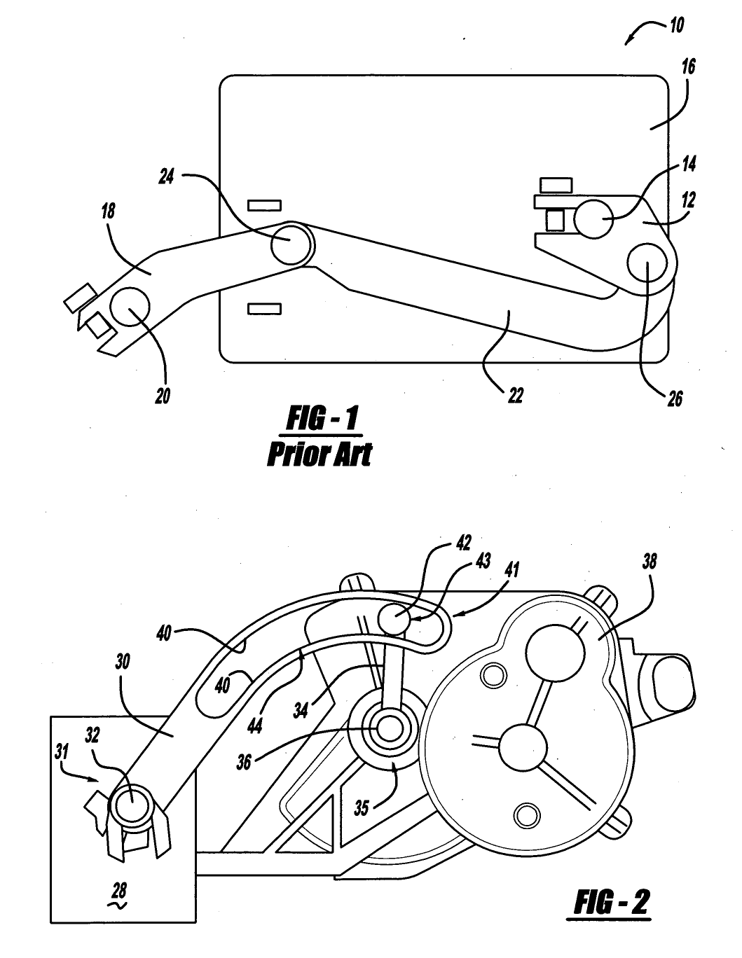

FIG. 2 shows a linkage arrangement in accordance with the present invention, connected to a turbocharger 28 via shaft 32. A first lever 30 has a first end shown generally at 31 connected to a shaft 32 of a control mechanism for the turbocharger. A second lever 34 has a first end shown generally at 35 that is connected to a shaft 36 which is part of an actuator portion 38 of the turbocharger 28.

The first lever 30 has an elongated slot 40 formed on the first lever 30. The slot 40 extends from a second end 41 of the first lever 30. The second lever 34 has a pin 42 located at a second end 43 of the second lever 34. The pin 42 is slidable disposed in the slot 40 to form a mechanical connection between the first and second levers 30, 34. The torque of the actuator shaft 36 causes the second lever 34 and pin 42 to rotate. The first lever 30 and the control mechanism shaft 32 will follow the movement of the second lever 34 and pin 42. The mechanical advantage of this lever arrangement, at any point through the rotation, is the ratio of the effective lever length of the first lever 30 and the effective lever length of the second lever 34.

The rate of changing the mechanical advantage through the rotation is further controlled by the shape of or contour 44 in the slot 40 of the first lever 30. Adjusting the contour 44 will provide a continuously variable rate through the rotation of the actuator shaft 36. Controlling the mechanical advantage through rotation provides a method of matching the required torque of the control mechanism to the available torque of the actuator 38. For example, a higher torque may be provided at a specific point through the rotation of the control mechanism, by adjusting the contour of the slot.

As the actuator 38 rotates the second lever 34, the pin 42 moves through the slot 40 changing the position of the second lever 34 relative to the second torque arm 30, thereby changing the amount of torque transferred therebetween.

It should be noted that the locations of the pin 42 and slot 40 could be reversed. For example, the slot 40 can be in the second lever 34 and the pin 42 can be located on the first lever 30. It is also within the scope of this invention for the pin 42 and slot 40 assembly to be replaced with some other devices to cause the same interaction between first lever 30 and second lever 34, such as a roller and cam assembly, a rack and pinion combination, or concentric shafts.

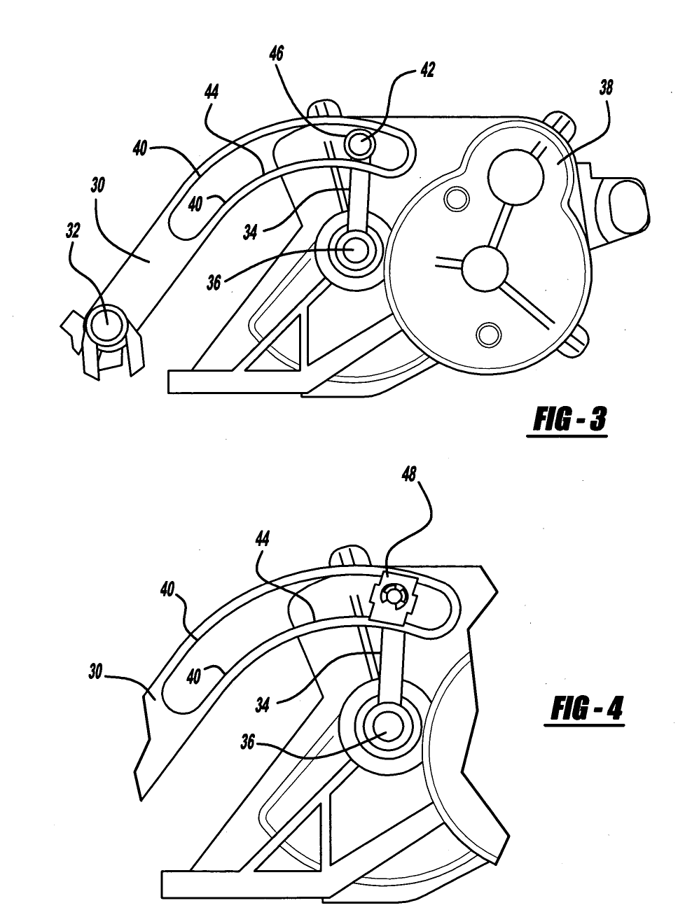

The interface of the pin 42 and the surface of the slot 40 can result in friction that will reduce the available torque to the control mechanism. In one embodiment a means of reducing friction is used to maintain the maximum amount of torque available to control the mechanism. The means can be a lubricant or low friction coating such as Teflon or boron nitride to reduce the torque loss. Alternatively a bearing, a bushing or some other type of friction reducing device is used. FIG. 3 shows the addition of a bushing or bearing 46 on pin 42 that reduces the friction caused by the pin 42 moving along the surface of the slot 40. The addition of the bearing 46 reduces the friction by rolling on the surface of the contour 44. The reduction in friction increases the torque available to the control mechanism.

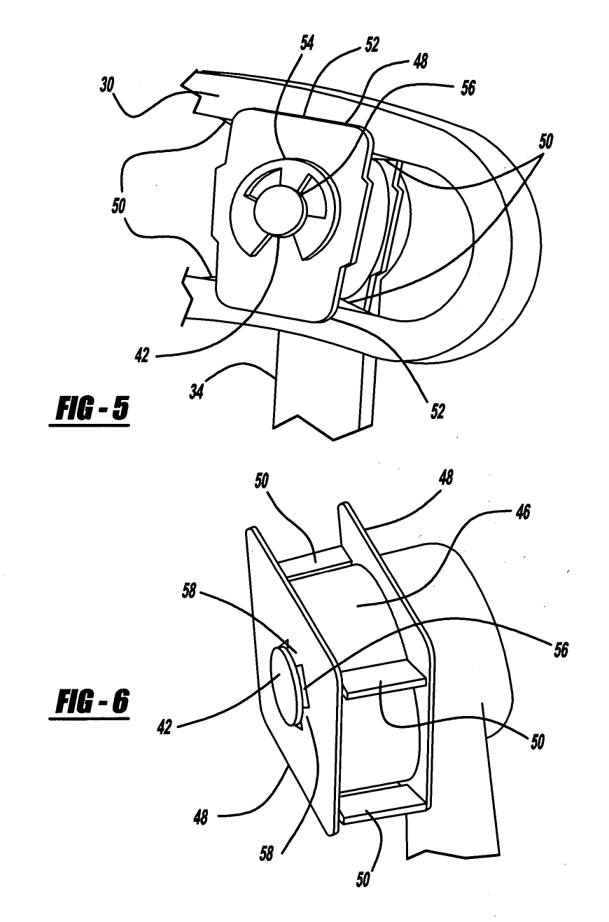

The operation of the lever arrangement may also be affected by debris such as dirt and oil. An alternate embodiment of the present invention includes a means for controlling or removing debris build-up. The means for controlling debris build- up is accomplished using a guard, a scraper or some other anti-contamination device. FIG. 4 shows a guard 48 that helps in preventing debris from coming in direct contact with and affecting movement of the pin 42 or bearing 46. The guard 48 has edges 50 and 52, shown in FIG. 5 that remove debris from the lever 34 and slot 40 as the pin 42 slides along the slot 40. The guards 48 are located on both sides of lever 30 and bearing 46, as shown in FIG. 6, and have been designed so that a single design for the part will fit in either location.

A “C” clip 54 is inserted into groove 56 in pin 42 to secure guards 48. It is possible to otherwise adhesively bond the guard 48 to the pin 42 such as by way of welding or adhering. An alternate method of retaining the guards 48 would be to integrally form the guard 48 with the pin 42. FIG. 6 shows flexible members 58 formed in guard 48 that press over pin 42 and engage in groove 56. This method eliminates the need for “C” clip 54.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A linkage assembly for obtaining a mechanical advantage comprising:
a first lever being rotatable on a first end, and having a second end, wherein said first end is connected to an actuator;
a second lever having a moveable first end connected to a device to be controlled, and having a second end; and
a mechanical connection for operably connecting said second end of said first lever with said second end of said second lever such that a variable mechanical advantage is created by varying the effective length of one or more of the levers when said actuator rotates said first lever.

2. The linkage assembly of claim 1, wherein said second end of said first lever has a pin.

3. The linkage assembly of claim 1, wherein said second end of said second lever has a slot for receiving said pin on said second end of said first lever.

4. The linkage assembly of claim 3, wherein said pin is placed on said second lever, and said slot is placed on said first lever.

5. The linkage assembly of claim 1, wherein said mechanical connection has a means of reducing friction.

6. The linkage assembly of claim 1, wherein one of said levers possesses a means of controlling debris build up in said slot.

7. The linkage assembly of claim 3, further comprising a guard member located on at least one side of said slot, for preventing the build-up of debris between said pin and said slot.

8. The linkage assembly of claim 7, wherein said guard member has a scraper edge that engages the surface of said slot for scraping debris off the surface of said slot as said pin moves along said slot.

9. The linkage assembly of claim 1, wherein said second end of said first lever has a roller, and said second end of said second lever has a cam.

10. The linkage assembly of claim 1, wherein said second end of said first lever has a pinion, and said second lever is comprised of a rack, and is bound by a torsion spring on said first end to offset torsion applied by said first lever.

11. The linkage assembly of claim 1, wherein said second end of said first lever has a hinge, and said second lever is comprised of concentric shafts, wherein said second end of said second lever is connected to said hinge on the end of said first lever.

12. The linkage assembly of claim 1, wherein said linkage assembly is used for controlling the vanes in a variable geometry turbocharger.

13. A control mechanism having a two-piece lever assembly for achieving a variable mechanical advantage, comprising:
a first lever, connected to an actuator on a first end, having a pin on a second end;
a second lever, having a slot on a first end, and connected to a pivot point on a second end;
a guard mounted on said pin, for removing debris as said pin moves along said slot; and
wherein said pin of said first lever is slidably disposed in said slot of said second lever.

14. The two-piece lever assembly of claim 13, wherein said slot is elongated and extends along the length of said second lever, providing a contour and changing the effective lever length of said second lever and said first lever.

15. The two-piece lever assembly of claim 13, wherein said pin includes a means to reduce friction when moving through said slot.

16. The two-piece lever assembly of claim 13, wherein said guard on said pin has two plates mounted on each end of the pin.

17. The two piece lever assembly of claim 14, wherein said guard has scrapers for removing debris from the inside of said slot as said pin moves along said slot.

18. The two piece lever comprised by to two plates of claim 14, wherein said guard removes debris from side of said lever as said pin moves along said slot.

19. A method of achieving a variable mechanical advantage for a control mechanism comprising the steps of:
providing a first lever connected to an actuator for rotation on a first end, and having a second end;
providing a second lever having first end for connection to a mechanism to be controlled, and having a second end coupled to said second end of said first lever; and
rotating said first lever;
interacting said second end of said first lever and said second end of said second lever creating a variable mechanical advantage; and
rotating said second lever, thereby controlling said mechanism.

20. The method of achieving a variable mechanical advantage as provided in claim 19, further providing a pin and guard assembly equipped with a friction reducing device on said second end of said first lever.

21. The method of achieving a variable mechanical advantage as provided in claim 19, further providing a slot for receiving said pin and guard assembly on said second end of said second lever.

22. The method of achieving a variable mechanical advantage as provided in claim 19, further providing for the prevention of debris build up in said slot by moving said pin and guard along said slot.

23. The method of achieving a variable mechanical advantage as provided in claim 19, further providing for said guard having two flat pieces fixed to the ends of said pin.

24. The method of achieving a variable mechanical advantage as provided in claim 19, further providing the steps of removing debris that may build up on the side of said slot by said guard sliding on the side of said slot as said pin moves through said slot.
